(19) United States
(12) Patent Application Publication
(10) Pub. No.: US 2011/0136070 A1
(43) Pub. Date: Jun. 9, 2011

(54) VIBRATING COMPRESSIBLE DENTAL PLATE FOR CORRECTING MALOCCLUSION

(75) Inventors: Clinton T. Rubin, Port Jefferson, NY (US); W. Brent Tarver, Houston, TX (US); Michael K. Lowe, Houston, TX (US)

(73) Assignee: ORTHOACCEL TECHNOLOGIES,INC., Houston, TX (US)

(21) Appl. No.: 12/935,560

(22) PCT Filed: Mar. 30, 2009
(86) PCT No.: PCT/US09/38767

§ 371 Date: Dec. 27, 2010

Related U.S. Application Data
(60) Provisional application No. 61/040,777, filed on Mar. 31, 2008.

(51) Int. Cl. A61C 7/00

(52) U.S. Cl. 433/2; 433/24

(57) ABSTRACT

A improved vibrating dental plate that allows accelerative forces in addition to vibrating forces to assist in remodeling is provided.

### PRIOR RELATED APPLICATIONS

This application claims priority to 61/040,777, filed Mar. 31, 2008 and incorporated herein by reference.

### FEDERALLY SPONSORED RESEARCH STATEMENT

Not applicable.

### REFERENCE TO MICROFICHE APPENDIX

Not applicable.

### FIELD OF THE INVENTION

The invention relates to systems and methods for correcting malocclusion.

### BACKGROUND OF THE INVENTION

Orthodontics is a dental specialty that treats malocclusion through the displacement of teeth, as well as control and modification of facial growth. This process is usually accomplished using continuous mechanical force to induce bone remodeling, thereby enabling the teeth to move to a better position. In this approach, orthodontic braces, consisting of an archwire that applies a continuous static force to the teeth interfaces with brackets that are affixed to each tooth. As the teeth slowly move under the pressure, the arch wires are tightened to again apply pressure. Although effective, this widely accepted approach to treating malocclusion takes about twenty four months on average to achieve success.

Dental researchers have long postulated that a pulsating force might also be used to successfully move teeth or to ease the pain of traditional orthodontics.

For example, U.S. Pat. No. 4,244,688, U.S. Pat. No. 4,348,177 and U.S. Pat. No. 4,382,780 describe devices used to pulse the teeth during orthodontic treatment, although each uses a different means of applying a pulse. The U.S. Pat. No. 4,244,688 patent employs a cumbersome external power source to power one to four small motors, whereas U.S. Pat. No. 4,348,177 uses pulsating fluids moved with the chewing motion of the jaw, and U.S. Pat. No. 4,382,780 uses a radio and speaker to set up a vibration. Each, however, is mounted on a cumbersome headgear that surrounds the head, as well as having intraoral portions connected directly to the teeth. Thus, the devices are cumbersome, difficult to construct, expensive and are less than convenient to use, reducing patient compliance.

U.S. Pat. No. 5,030,098 by Branford describes a hand-held device that simulates chewing in order to treat periodontal disease by increasing blood flow to the gums. The mouthpiece has a perforated malleable plate such that biting of the mouthpiece results in the plate adapting to the user's bite which, of course, varies with each user. The external vibrator imparts motion to the mouthpiece and thus the user's teeth. The device, however, uses an external power source. Further, the dental plate is brass, and is very unpleasant to bite on, thus necessitating a second exterior coating and further complicating manufacture and cost. Although this device allows some small degree of masticating movement by the user, the degree of motion is actually very small. Further, since the device is not designed for orthodontic use, there is no motivation to modify the device to allow a greater degree of movement.

U.S. Pat. No. 5,967,784 by Powers describes a similar device to that described by Brandford. It too is a hand-held tooth vibrator that is simple and has an exterior motor housing connected to a vibrating interdental mouthpiece portion for gripping between the teeth of the patient. The exterior housing contains a battery and a switch for selectively operating a motor with an off-center weight attached to the motor rotating shaft for creating a high frequency vibration that vibrates the entire device. The mouthpiece is disposable, making the system affordable and more convenient to use. The patent teaches using the device to alleviate pain by inserting the interdental mouthpiece between the teeth and clenching and releasing the teeth over the mouthpiece, in an attempt to engage as many teeth as possible in the transmitted vibrations. The vibration is believed to increase blood flow, thus alleviated pain.

The devices of Branford and Powers are superficially similar to those of the invention herein, but there are significant differences. Most importantly, there is no recognition in either patent that the device can be used for tooth remodeling. Thus, the shape of the dental plate in each case is a very flat U- or Y-shaped member that is largely ineffective for remodeling. Additionally, the vibration is not optimized in frequency and amplitude for remodeling. Finally, neither device is programmable, thus the dentist cannot optimize its usage for each patient, nor monitor patient compliance. All of these shortcomings reduce the effectiveness of these devices for remodeling uses.

U.S. Pat. No. 6,632,088 describes a bracket with powered actuator mounted thereto to provide vibration, but this device appears to also be held completely internally to the patients mouth, thus again being cumbersome, and thus may affect patient comfort and ultimately patient acceptance of the device.

Mao was probably the first to show that the use of cyclic forces could improve dental straitening in rabbits (see U.S. Pat. No. 6,684,639, U.S. Pat. No. 6,832,912, U.S. Pat. No. 7,029,276). Certain dynamic loading patterns (cycling force with rest periods) were shown to greatly increase bone formation compared to basic dynamic loading. Inserting rest periods is now known to be especially efficacious as it allows mechanosensitivity to be restored to the bone tissue. A point of diminishing returns is reached within each loading session. Therefore, intermittently loading cyclic force can increase the rate of bone formation significantly.

However, the device provided by Mao uses arch wires and brackets with a centrally mounted motor that is held inside the mouth. Therefore, the device is uncomfortable for the patent to use.

What is required is a simple, affordable device that is optimized to stimulate osteogenesis and accelerate tooth movement, that can be customized for patient use and wherein patient usage can be monitored. Preferably the device can be used with all existing orthodontic devices or can be used alone to remodel tooth alignment.

### SUMMARY OF THE INVENTION

The invention provides an improvement over prior orthodontic devices, the improvement comprising a bite plate configured to allow accelerative as well as vibrational forces to be applied to the teeth. Generally speaking the bite plate contains both upper and lower portions that are capable of relative movement therebetween. This allows the teeth to move up and down in a normal masticative motion, in addition to being vibrated by the motor. Therefore, the teeth move into- and out-of the bite-plate space, thus imparting an accelerative force to the teeth. The additional movement further accelerates remodeling over vibrational forces alone.

By “accelerative force” what is meant herein is a force applied to teeth along the occlusal surface to root line, e.g., the same direction as masticative forces.

Thus, the invention also includes a method of dental remodeling by applying vibratory forces to teeth at between 0.1 to 1200 Hz (or 0.1 to 1000 Hz or 0.1 to 400 Hz or 10-30 Hz; or 50 to 150 Hz) and force of about 0.1-10 Newtons (or 0.5-5 or 1-3 or 0.1 to 1 or 0.5 to 1 Newtons) for a period of 1-60 minutes, preferably about 1-30 or 1-10 minutes, and simultaneously applying an repetitive accelerative force in a direction from the occlusal surface to the root of a tooth. This is followed by a period of recovery, ranging from 2-24 hours, preferably from 4-12 hours, and the cycle is repeated until one or more teeth are successfully remodeled.

Although the preferred frequency is about 50-150 Hz, higher frequencies are also possible, including up to about 1000 Hz or even 1200 Hz, the choice being dictated by manufacturing considerations and patient preference. However, the usable force range is more limited, as patients cannot tolerate high forces. Some patients may have difficulty tolerating forces above 3 Newtons; some patients even cannot tolerate forces between 1 to 3 Newtons. Individual adjustment may be needed depending on each patient's condition.

The device is programmable and has memory capacity, as described in co-pending application Ser. Nos. 11/773,849 and 11/773,858, incorporated herein by reference. Thus, the frequency, amplitude and duration can be modified as needed, and the usage of the device monitored by the dentist or patient. Communication with other processors can be direct or wireless.

The device can be used alone, or in combination with other orthodontic devices. Thus, the user of traditional orthodontic fixed appliances or aligner based treatments can use the device to speed remodeling, or a new user can employ the device alone provided that the user's application of the device is of sufficient regularity so as to achieve its intended effect.

There are several means of constructing a bite plate that allows accelerative motion of the teeth into and out of the bite space. In the simplest device, upper and lower portions of the bite plate are separated by about a space of at least about 2 mm inches, preferably 4-5 mm and even as much as 10, 20 or 30 mm, depending on user size. The bite plate is made of a material flexible enough to accommodate a chewing motion of the user, and has sufficient resilience to return to its original configuration when the bite relaxes. The biting action allows the teeth to move into- and out-of the bite-plate space, thus imparting an accelerative force to the teeth when in use. Preferably, the bite plate is, or is covered with, a smooth polymeric material, such as polyethylene, polyurethane, polypropylene, polyvinylchloride, vinyl, nylon, teflon, silicon rubber or similar material. Thus, it is inexpensive to fabricate, and can be considered disposable. Harder materials such as ceramic, metal, or more brittle plastics or resins could also be used, but it is expected that the user will prefer a material with some degree of malleability for comfort.

By “bias” what is meant is that the upper and lower portions of the bite plate tend to separate after being forced together and return to their original (or nearly so) position. The bias between the upper and lower portions of the bite plate can be provided in any convenient way. In one variation of the compressible space embodiment, the bite space is filled with air or some other biocompatible gas. In another embodiment the space is fluid or gel filled or filled with an elastomeric material that biases the upper and lower portions to their original positions. In another embodiment, internal springs or hinges are used to bias the bite plate to its original shape. In yet another method, the bias is provided by material memory. Combinations of the above can also be used.

In yet another embodiment, the bite plate comprises upper and lower portions that are hingably coupled. The device may be hinged at the distal end, centrally, or individual tooth portions may be hinged. In all cases, the hinge functions to allow the two portions to open and close with the motion of the jaw. This motion allows the teeth to have additional movement and thus to remodel even faster than with the prior art devices. It is a significant improvement over the prior art devices, wherein the bite plate itself was a single piece, completely static, and the user clenched down in the bite plate in order to impart vibrational forces to the teeth.

It is also possible to employ a hinge at the frontal (medial) portion of the bite plate, particularly where more force or motion is desired distally, but the distal hinge is expected to be more comfortable for the user, since the jaw itself is distally hinged.

The hinge or hinges can be any type known in the art, provided that it its material and shape are compatible with intraoral use. In one embodiment, a simple coiled wire hinge is used. In another embodiment, the hinge is integral to the upper and lower bite plates and relies on material memory to provide resistive forces.

The actual shape of the bite plate is very important to remodeling uses. Ideally, the plate should contact the maximum surface area of the teeth, even including the gums, in order to optimize the transfer of vibrational forces to each tooth. Thus, in preferred embodiments, the bite plate is customized to fit the patient's dental arches. This can be done for each patient, or an array of sizes can be pre-manufactured for selection by the dental practitioner.

Alternatively, in a preferred embodiment, the core of the bite plate is malleable (for example aluminum) and covered with a polymeric coating, and the angle between of the two halves of the bite plate can be modified slightly by applying inward pressure on the distal ends of the bite plate (e.g., medial pressure applied at the molar portion of the bite plate).

In another embodiment, at least the outer or coating material of the bite plate is heat sensitive. Thus the bite plate can easily be customized for each user by heating the material to its softening point, cooling it somewhat, and then biting into the malleable material to shape it to the user's mouth, in much the same way that “boil and bite” commercial tooth guards are customized by each user. In this embodiment, patient comfort is maximized, and yet the bite plate is customized to contact even the most irregular of bite surfaces and contacts both the exterior (facial=labial and buccal) and interior (lingual) surfaces of the teeth, as well as the occlusal (bite) surfaces.

More particularly, the orthodontic appliance of the invention has a vibrational source, preferably extraoral, capable of providing a vibratory force at a frequency of between 10 to 1000 Hz and a force of 0.1-10 Newtons that is operably and sometimes removably connected to the bite plate so that the entire bite plate can vibrate. The bite plate has upper and lower portions that are biased to be separated by at least 2 mm. In use, the upper portion and the lower portion move together in response to the biting pressure of the user, but return to their original position when said pressure is removed.

Many different bite plate shapes are possible, depending on which teeth need to be treated. However, generally, the bite plate is shaped to contact the occlusal surface of all teeth, and thus a U-shaped bite plate is preferred. However, the bite plate should conform to the anatomy of the dentition, whatever shape that may be in a given patient. Thus the “U-shape” is intended to generally reflect the shape of the dentition and accommodate considerable patient variation. Hypererupted or hypoerupted teeth are out of occlusion in the vertical direction, and therefore it may be required to modify the bite plate to the dentition. For example, by adding material to reach a recessed tooth.

In preferred embodiments, the bite plate also has one or more perpendicular edges or phalanges, said edges being positioned along the facial (outer edge of U) or lingual edges (inner edge of U) of the U-shaped bite plate and being designed to contact the facial and/or lingual surfaces of one or more teeth and possibly even the gum line. In this embodiment, there is maximum vibratory communication with the teeth, and thus maximal effectiveness. Where teeth are out of alignment with respect to the facial surface, the plate edges may need to be modified to accommodate such variation.

Malocclusion is defined herein as the misalignment of teeth and/or incorrect relation between the teeth of the two dental arches. Malocclusion include orthodontic or orthognathic problems that lead to a “bad bite” including overbite, underbite, crowded, missing, or crooked teeth, extra teeth, misaligned jaw or craniodental misalignments.

The device of the invention can improve a variety of maxillofacial applications including malocclusion, trauma repair, temporomandibular joint and muscle disorders (TMJDs), Lefort fractures, craniofacial anomalies, bony defects, dentofacial deformities, dental implants, as well as tooth, muscle, nerve, tendon, ligament, bone, and connective tissue repair.

As used herein, vibratory or vibrational source can be intra- or extra-oral vibration generating equipment, but is preferably extraoral. Vibrational sources include electromagnetic motors, piezoelectric devices, mechanical actuators, and the like. Vibrations may be oscillating, random, directional, circular, and the like. Vibrational forces may also be referred to as non-static forces interchangeably herein. In one embodiment, an electromagnetic vibrator mechanically vibrates the bite plate.

Quite effective vibrators are well within the skill of the art, and several are described in the patent literature. For example, US2007299372, US2007255188, US2007208284, US2007179414, US2007161931, US2007161461, US2006287620, each incorporated by reference, describes various massagers (vibrators) and their motors.

In one embodiment a processor controls the vibratory source. The processor can be programmed to change the force, its direction, frequency, wave form, amplitude, duration or any other operating parameter. In a preferred embodiment the processor actively communicates with the user to provide input related to device use, duration of use, and/or biting force, too hard or not hard enough.

In one embodiment, the interior of the bite plate contains a switch that is activated when sufficient pressure is applied to the bite plate. Thus, no additional on/off switch is needed and the vibrator automatically commences when the bite plate is in use.

In another embodiment, the processor can send and/or receive information from a remote processor. The processor communicates with a remote computer via internet, phone, wireless, infrared, satellite, cellular, cable, modem, or other form of electronic communication. The processor can run software that captures usage frequency and duration. In yet another aspect, a method for recording the compliant use of an orthodontic device, where the device has electronic media that captures information about usage, tooth position, and/or device function for download and analysis.

Batteries, either non-rechargeable or rechargeable, or other electric source can drive the vibrational source. If a rechargeable battery is used it can be charged from any type of power source including USB ports, RS-232 ports, FireWire ports, transformer, or unique docking power source, for example.

In addition to direct purchase of a complete system, leasing, rental, per procedure or other shared usage can reduce patient cost and allow recycling of system components. Specifically, the system provides methods for recycling the vibratory source, batteries, plugs, wires, and extraoral components, as well as motorized and/or computerized parts.

The system supports a business model that allows for a non-disposable component of the orthodontic treatment to be variable and proportional in cost to the duration of the treatment. The bite plate, in contrast, can be disposable or non-disposable. The device can be leased, rented, or purchased on a procedure basis to the patient directly or through the orthodontist or by a third party. The proposed system also increases orthodontic case throughput and therefore office efficiency.

The system enables an efficacious, yet quick treatment period of non-static force that involves rapidly changing the forces on the teeth. The system can be worn for a predetermined periods including daily regimens, weekly regimens, monthly regimens or any other suitable duration of time. The patient may wear the device at home for daily or weekly treatments, or an orthodontic professional may offer longer treatments in the office. The healthcare professional can measure patient compliance and usage patterns between appointments. Because an accurate and complete record of compliance is kept for orthodontist review, patient compliance will be vastly improved.

### BRIEF DESCRIPTION OF THE DRAWINGS

FIG. 1 shows one embodiment of an orthodontic treatment device 10.

FIG. 2 shows a second embodiment of an orthodontic treatment device 20, including a close up top view of a bite plate that can be modified to include a collapsing space or hinge (not shown).

FIG. 3 shows a top view and side view of a compressible space embodiment 40. In this embodiment, the space 43 is reversibly compressible. Several hinge and or coils are shown inside the space to assist in biasing the compressible space to its fully expanded position.

FIG. 4 shows a bite plate 50 with two distal hinges 51.

FIG. 5 shows an embodiment with a medial hinge. In this embodiment, there can be single or double bite plates, although the double bite plate shaped like dragon-fly wings are preferred.

FIG. 6 shows a complex embodiment where a hinge can be placed at one or more individual teeth, thus allow customized treatment of particular teeth.

FIG. 7 is a diagram showing dental anatomy.

FIG. 8 shows an exemplary diagram of control electronics used with the system of FIGS. 1-2.

### DESCRIPTION OF EMBODIMENTS OF THE INVENTION

Referring now to the drawings in greater detail, there is illustrated therein various vibratory dental appliances.

### EXAMPLE 1

### Vibrational Orthodontic Device

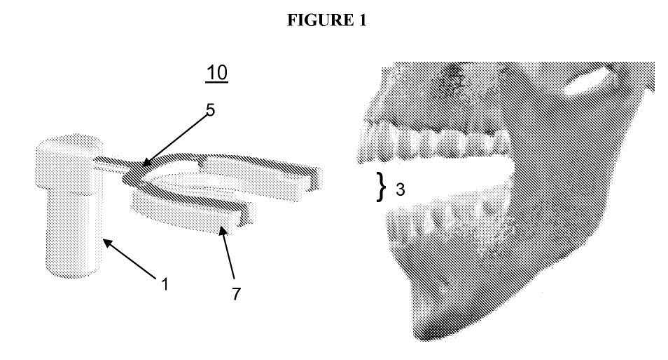

FIG. 1 shows one embodiment of an orthodontic treatment device 10. The device 10 has an intraoral bite plate 3 that is inserted into a patient's mouth. The bite plate 3 is connected to an extraoral vibration source 1 and interfaces with the dentition. The device 10 is clamped down by the patient's jaw on the bite plate 3 to secure it between the dental arches in the patient's mouth. The vibration source 1 in this embodiment is activated by pushing a button (not shown) mounted on the extraoral apparatus. The vibration source can alternatively be activated by sensing the patient bite pressure as stimuli with a microprocessor or some other mechanism translating the external stimuli into device function, including moisture or temperature sensing as well as salivary mineral content sensing.

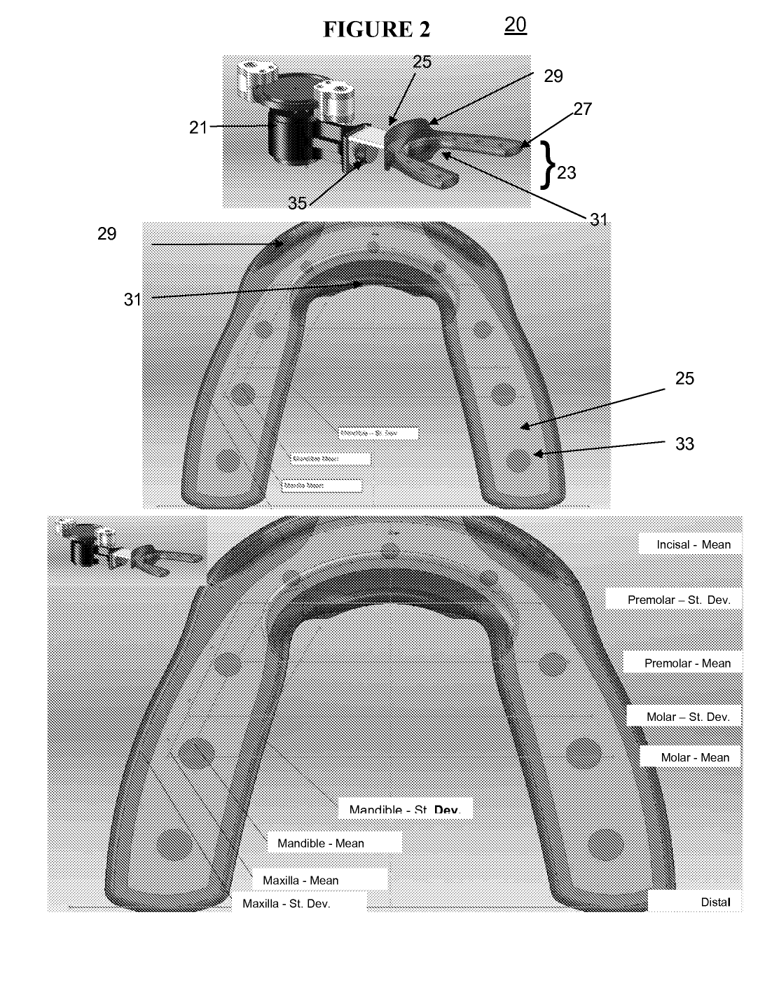

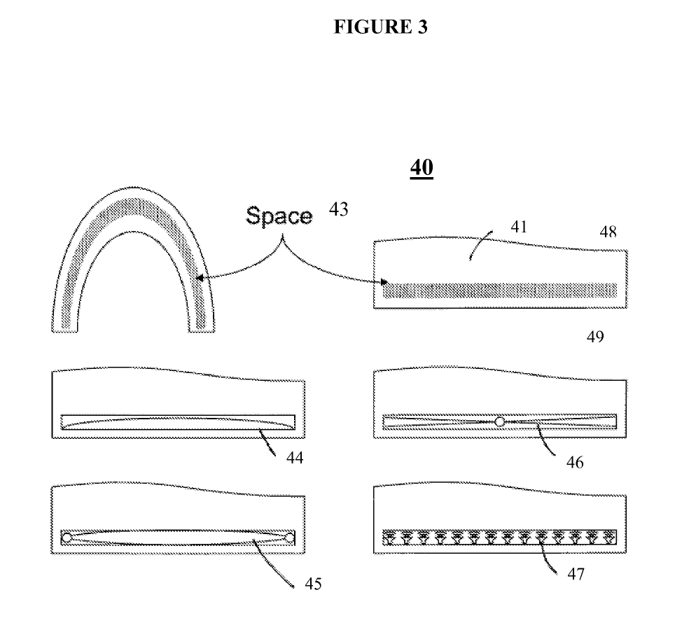

FIG. 2 shows another embodiment of an orthodontic treatment device 20. The bite plate 23 is connected to an extraoral programmable vibration source 21 and interfaces with the dentition, as above. In this case, the bite plate has vertical portions or edges (29, 31) shaped to contact the facial and lingual surfaces of the teeth, thus maximally vibrating the teeth while in use.

This embodiment has a bite plate core 25 that is composed of a first material, typically metal, that is covered with a polymeric molded surface 27 with the appropriate configuration. The core 25 provides strength and good coupling to the vibration source (see screw or locknut 35), and the polymer is easily shaped and more comfortable for intraoral use than metal. In the diagram, the core 25 has holes 33 which serve to lighten the core and reduce the amount of material used in its manufacture. Edges 29 and 31 are positioned roughly perpendicularly to the bite plate 23 and serve to provide additional contact with tooth surfaces.

The enlargement of the bite plate in FIG. 2 shows the measurements that are made to properly fit the bite plate to the patient's dental arches, including the average measurement [mean] and standard deviation (St. Dev.).

FIG. 8 shows an exemplary diagram of control electronics used with the system of FIGS. 1-2. The functional electromechanical components include a processor 50 that can be a low power microcontroller. The processor 50 stores instructions and data in a memory 52. The processor drives an actuator 54 such as an electrical motor or a piezoelectric device, among others. The system receives energy from a battery 62 that can be rechargeable. The processor 50 can be programmed or updated through a communication port 60 such as a USB port. Alternatively, the processor 50 can be wirelessly updated through a wireless transceiver 58 connected to an antenna 59. The battery 62 can be of any type and can be a rechargeable type with a bite plate docking port that recharges the battery upon insertion thereto. The processor 50 can also communicate with an optional sensor 64 to capture patient dental data if needed. The processor 50 can also simply transmits its operational parameters through the communication port 60 or the wireless transceiver 58 so that a dental professional, patient, or a third party can monitor treatment progress as required.

The actuator 54 can include a motor driven bite plate or platform. Upon activation, the plate or platform, which can be of any shape or thickness, and comprised of any material, sufficient to come into and out of contact with the dentition, in part or in whole, vibrates in a manner that delivers the necessary force. The device can have one or more interface points across the dentition, or can interface with the entire dentition in aggregate and in both arches simultaneously. This movement in total completes one cycle. The system embodied as the device described here pulsates or vibrates at a frequency of between about 0.1 Hertz to about 400 Hertz.

In one embodiment, the vibrating bite plate can transmit a force of about 0.1 to 10 Newtons for about 1-60 minutes a day at a frequency of between 0.1 to 400 Hz as discussed above. However, the prescribed clinical application of forces can be over any duration, frequency, and time of day combination pattern. Upon completion of a session of use, the device automatically shuts off. Pacing indicators in the form of an audible tone, cycle stutter, or by some other means provide feedback to the patient regarding elapsed time and time remaining in the current session of activation. These indicators can be of any form and frequency; the current described system embodies the indicators as one second tones at five-minute intervals for the first fifteen minutes, representing a tone at minute five, minute ten, and minute fifteen; and then a final tone at minute nineteen, indicating that the user has 60 seconds of use remaining. Other indicators and/or suitable treatment intervals can be used to provide notice to the patient. For example, the professional can specify treatment intervals that mix and match usage patterns to get to the 20 minutes such as 4×5 minutes or 10×2 minutes or some other combination thereof.

After the device shuts off, the patients simply releases the bite plate and removes the device. Data capture related to usage frequency and duration updates real time. As such, the device representation of this data post-use will indicate one additional session, and twenty additional minutes in duration of use, as compared to the same device immediately prior to the session.

In one embodiment, the battery 62 is rechargeable and can be inserted into its charger base between uses. Alternatively, the device can embed the battery 62 within its housing, and the entire device is placed into a rechargeable base (or the battery does not require re-charging). The charging of the battery can be done using power from the USB port 60. Alternatively, any suitable computer or electrical connection can be provided to charge the battery. For example, the battery can be charged using RS-232, Firewire, or through a 5V hook. Further, a standard DC converter can be used to charge the battery.

The device can be hermetically sealed to be airtight and water tight, and can withstand immersion or exposure to water or moisture. It can and should be stored at room temperature. The battery 62 used in this particular embodiment is both memory-free and maintenance-free.

The application of cyclic forces can be used to perform bone modeling and/or remodeling as well as more rapid tooth movement that may occur without bone modeling or remodeling. The bone remodeling and accelerated tooth movement across all types of displacement includes: rotation, translation, intrusion, extrusion, tipping and osteogenesis. This induced accelerated remodeling of bone is relevant for both the alignment and movement of teeth, in any plane, including horizontal and vertical, anterior and posterior, mesial and distal, and facial (buccal and labial) and lingual. Bone remodeling is also useful for the incorporation and durability of dental implants.

The delivery of the cyclic forces to the teeth and craniofacial bones can be facilitated by contact or any form of interaction with the dentition, including any tooth, group of teeth, or arch. The interface can also include any dental tissue including tissues of the tooth, enamel, dentin, cementum, and pulp, and appliances, especially aligner trays, which can be of any commercial or non-commercial brand or design.

The system can be used in conjunction with lingual braces, facial braces, or any combination across either arch or any quadrant for both. It is also contemplated as compatible with any robotics-based or other wire-bending optimization technology. The system is also compatible with clear aligner technology treatment plans, including the INVISALIGN® treatment approach.

The system can be used in conjunction with a new treatment start from the very first appointment at which the orthodontic treatment begins, or it can be slotted into a treatment in progress at any point during the course of the treatment, up to and including the very last clinical stage.

An embodiment of the system can be made available for sale directly to consumers over-the-counter with no orthodontist or healthcare professional involvement. The application being contemplated can be used to both align and mal-align either a single tooth, the entire dentition, or any combination of teeth groups. Teeth being displaced as a result of the non-static forces delivered by this device can include natural teeth without any dental work, natural teeth with dental work including operative restoration of any nature with any material, crown and bridge work, endodontically treated teeth, periodontally treated teeth, teeth surrounded by periodontally treated hard and soft tissue, and any type of dental implant, including micro implants used for orthodontic or tooth movement purposes. The proposed system can be used in conjunction with any type of dental or dentofacial surgery or treatment of trauma to any soft or hard tissue structure.

The system can be rechargeable or non-rechargeable and can be configured in a manner that would allow either patient mobility or immobility during use. It can be programmed with specific instructions and usage pattern directions by the healthcare professional to ensure safety or for other reasons, and is configured to give the healthcare professional the option of not allowing the patient to have control over the programmed settings.

### EXAMPLE 2

### Collapsible Bite Plates

When the bite plate is configured to allow significant masticating motions of the jaw, additional accelerative forces are brought into play, thus improving the speed of remodeling. In its simplest embodiment, the bite plate 41 has an upper surface 48 and lower surface 49, separated by a space 43. The space 43 is compressed with the masticating motion of the jaw, but returns to its original position when the pressure is removed. The resilience may be a consequence of material memory or the inclusion of an elastomeric filler inside the space, such as a gel, foam or polymer filler. Alternatively, the space may be mechanically restored, such as with the use of springs or hinges 44, 44, 45 or internal coils 47 that bias the space towards separation.

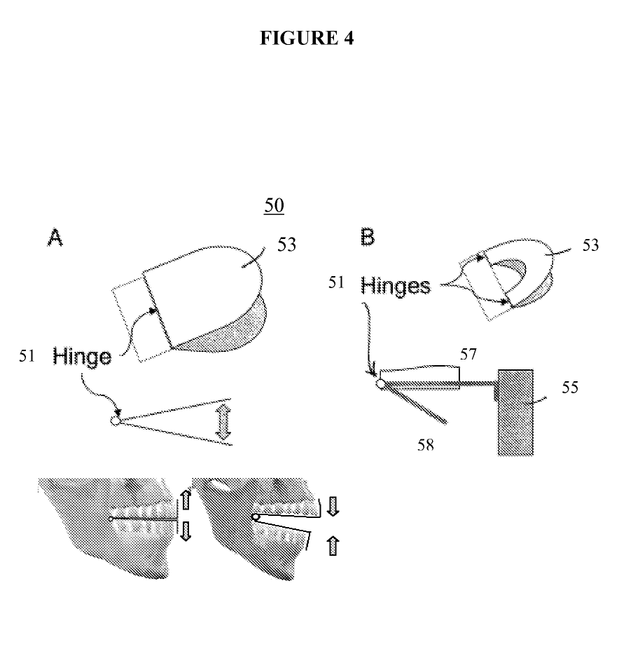

The vibrational orthodontic device may also be hinged to facilitate insertion and apply directional mechanical force. In one embodiment a semicircular or U-shaped orthodontic device is hinged 51 along the distal surface as in FIG. 4. The bite plate has top 57 (palatal) and bottom 58 (lingual) portions, connected distally by a hinge or hinges 51. In the diagram, the top portion 57 of the bite plate is connected to the vibrational source 55, but this could also be connected on the bottom plate 58. Upper and lower plates hinged together along the distal surface provide mechanical forces along the same planes as the maxilla and mandibular teeth. Cyclic force applied in this manner can be used to isolate the temporal mandibular joint (TMJ). If the hinge is reversed and placed on the frontal surface of the bite plate (not shown), greater force can be placed on the molars and TMJ. By placing the hinge on the right or left side, greater force can be applied to the opposing jaw, increased bone and tooth pressure and thus increased osteogenesis.

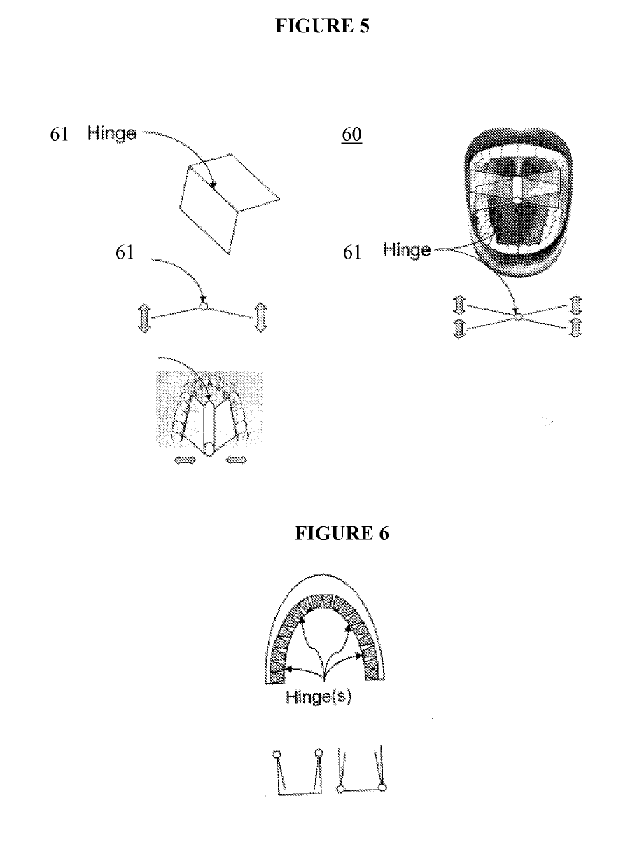

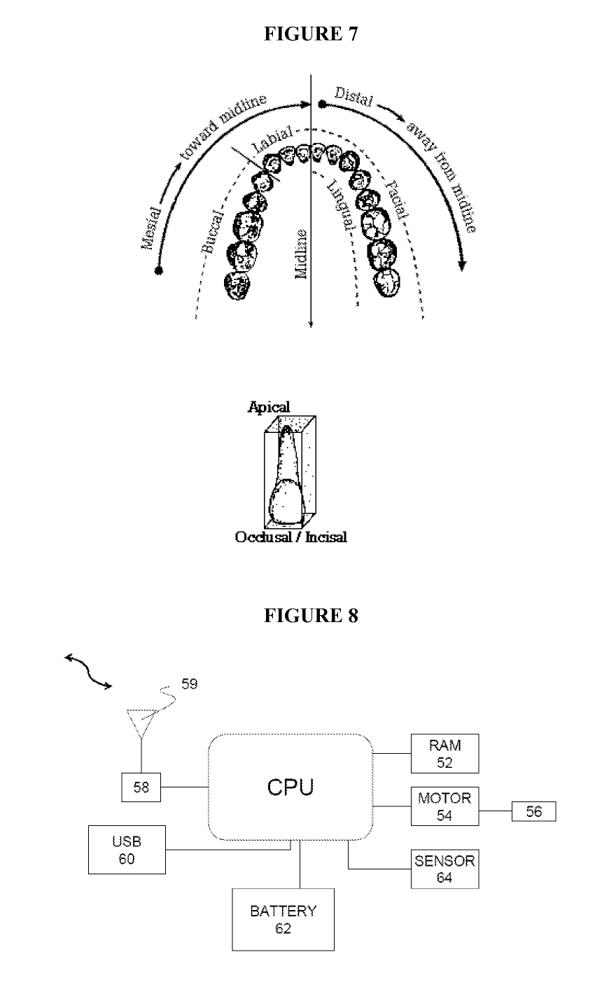

Another embodiment hinged in the middle is shown in FIG. 5 where the hinges 61 can connect a single (“butterfly”) or double pair (“dragonfly”) of plates. In this figure, the plates are simply shown as rectangular bite plates that only connect to the buccal teeth, but the bite plate can of course be shaped to contact every tooth if desired. Using a central or medial hinge will apply more outward pressure and can be incorporated into palatal expanders. By increasing non-static forces, the time a palatal expander must be worn and discomfort when wearing the palatal expander will be decreased. Restructuring of the maxilla and teeth will be improved by increasing the amount of osteogenesis. Because the butterfly hinge is expandable, it is easier to insert and pressure can be increased over time without having to remove, adjust or resize the palatal expander. The butterfly or dragonfly apparatus can also be used to apply up and down forces to the occlusal surfaces of the upper and lower jaw. This may be especially useful for isolating molars and/or premolars with a smaller easier to insert device. The “hinge” of the butterfly or dragonfly apparatus may contain the processor, batteries, and motors to drive the hinges thus expanding the wings against the lingual surface of the teeth. Alternatively an extraoral vibrator may be connected to the frontal surface of the butterfly apparatus.

A series of smaller mechanical hinges along the interior of the mouthpiece, as in FIG. 6 can be used to direct non-static forces to individual teeth. By customizing the mouthpiece hinges, hinges may be placed on the labial, occlusal, lingual, or other surfaces of the tooth. The hinges may be oriented from top to bottom, bottom to top, front to back, back to front and either side to side for each tooth or groups of teeth. This allows increased pressure and vibration at specific locations within the mouth. By placing the hinge at the gum line and the open end at the occlusal surface the root of the tooth will receive less pressure while the occlusal surface will be pushed more dramatically. On the opposing side of the tooth or groups of teeth, the hinge may be placed at the occlusal surface and open toward the gum line. Individually, using specific hinge configurations one or more teeth may be forced in one or more directions. This improves treatment by applying directional pressure to move teeth independent of overall movements in the mouth. This can improve the rate of treatment and the outcome of treatment as well as the type of treatment, reducing the amount of time required for “cantilever” procedures. These increased force procedures are used to move severely displaced teeth.

The following references described herein are expressly incorporated in their entirety:

U.S. Pat. No. 4,244,688, U.S. Pat. No. 4,348,177, U.S. Pat. No. 4,382,780

U.S. Pat. No. 5,030,098

U.S. Pat. No. 5,967,784

U.S. Pat. No. 6,632,088

U.S. Pat. No. 6,684,639, U.S. Pat. No. 6,832,912, U.S. Pat. No. 7,029,276

Ser. Nos. 11/773,849, 11/773,858

What is claimed is:

1. An orthodontic appliance, comprising:
a) a vibrational source capable of providing a vibratory force at a frequency of between 0.1 to 1200 Hz and a force of 0.1-10 Newtons;
b) a bite plate operably connected to the vibrational source so that the entire bite plate can vibrate,
said bite plate having an upper portion and a lower portion separated by at least 2 mm wherein the upper portion and the lower portion are movably connected to each other so as to allow the upper portion and the lower portion to move together in response to a pressure and being biased to return to their original position when said pressure is removed,
said bite plate being shaped to contact the occlusal surface of one or more teeth.

2. The orthodontic appliance of claim 1, wherein the vibrational source is extraoral.

3. The orthodontic appliance of claim 1, wherein the vibrational source further comprises a processor to control the vibrational source and to capture usage frequency and duration information.

4. The orthodontic appliance of claim 3, wherein the processor communicates usage frequency and duration information to a remote computer.

5. The orthodontic appliance of claim 1, further comprising a rechargeable battery to drive the vibrational source.

6. The orthodontic appliance of claim 1, wherein said bias is provided by one or more coils.

7. The orthodontic appliance of claim 1, wherein said bias is provided by one or more hinges.

8. The orthodontic appliance of claim 1, wherein said bias is provided by material memory.

9. The orthodontic appliance of claim 1, wherein said bias is provided by one or more springs.

10. The orthodontic appliance of claim 1, wherein said bias is provided by a pair of hinges connecting the upper and lower portion of the bite plate at a distal end of the bite plate.

11. An orthodontic appliance, comprising:
a) an extraoral vibrational source capable of providing a vibratory force at a frequency of between 0.1 to 400 Hz and a force of 0.1-10 Newtons, wherein the vibrational source further comprises a processor to control the vibrational source and to capture usage frequency and duration information and a wireless communication port;
b) a bite plate removably connected to the vibrational source, said bite plate having an upper portion and a lower portion being biased to be separated by at least 2 mm, wherein the upper portion and the lower portion are movably connected to each other so as to allow the upper portion and the lower portion to compress in response to a pressure and return to their original position when said pressure is removed,
c) said bite plate being U-shaped to contact the occlusal surfaces of the teeth and further comprising one or more perpendicular edges to contact a facial or lingual surface of one or more teeth.

12. The orthodontic appliance of claim 11, further comprising a rechargeable battery to drive the vibrational source.

13. An orthodontic appliance of claim 11, wherein said bite plate is disposable.

14. An orthodontic appliance of claim 13, wherein said bite plate further comprises a metal core and a polymeric coating.

15. An orthodontic appliance of claim 13, wherein said bite plate further comprises a metal core and a polymeric coating that can be shaped to fit a patient dental arches by heating at 100° C., cooling and applying a biting pressure to shape the polymeric coating.

16. An orthodontic appliance of claim 11, wherein said bite plate further comprises a metal core and a polymeric coating.

17. An orthodontic appliance of claim 11, wherein said extraoral vibrational source further comprises a battery.

18. An orthodontic appliance of claim 11, wherein said extraoral vibrational source further comprises a rechargeable battery.

19. The orthodontic appliance of claim 11, wherein said bias is provided, at least in part, by one or more spring coils or one or more hinges or by material memory.

20. The orthodontic appliance of claim 11, wherein said bias is provided by a pair of hinges connecting the upper and lower portion of the bite plate at a distal end of the bite plate.

21. A method of dental remodeling, comprising first applying vibratory forces to teeth at between 0.1 to 400 Hz and a force of 0.1-10 Newtons for a period of 5-60 minutes and simultaneously applying a repetitive accelerative force from the occlusal surface to the root of a tooth, second allowing a period of recovery from 2-24 hours, and repeating the first and second steps until one or more teeth are remodeled.

22. An orthodontic appliance, comprising:
a) an extraoral vibrational source capable of providing a vibratory force at a frequency of between 10-30 Hz and a force of 1-3 Newtons, wherein the vibrational source further comprises a processor to control the vibrational source and to capture usage frequency and duration information and a wireless communication port;
b) a bite plate removably connected to the vibrational source, said bite plate having an upper portion and a lower portion being biased to be separated by at least 5 mm, wherein the upper portion and the lower portion are movably connected to each other so as to allow the upper portion and the lower portion to compress in response to a pressure and return to their original position when said pressure is removed,
c) said bite plate being U-shaped to contact the occlusal surfaces of the teeth and further comprising one or more perpendicular edges to contact a facial or lingual surface of one or more teeth.

23. A compressible bite plate, comprising:
a) a bite plate having an upper portion and a lower portion being biased to be separated by at least 2 mm, wherein the upper portion and the lower portion are movably connected to each other so as to allow the upper portion and the lower portion to compress in response to a pressure and return to their original position when said pressure is removed,
b) said bite plate being generally U-shaped to contact the occlusal surfaces of a user's teeth and further comprising one or more perpendicular edges to contact a facial or lingual surface of the teeth.
